(19) United States
(12) Patent Application Publication
(10) Pub. No.: US 2015/0358714 A1
(43) Pub. Date: Dec. 10, 2015

(54) Earbuds Conduit

(71) Applicant: Linda Bowen, Houston, TX (US)

(72) Inventor: Linda Bowen, Houston, TX (US)

(21) Appl. No.: 14/296,455

(22) Filed: Jun. 5, 2014

(51) Int. Cl. H04R 1/10

(52) U.S. Cl. CPC H04R 1/1033

(57) ABSTRACT

The growing personal music player industry has resulted in more and more consumers using the in-ear “earbuds” to listen to their music. While the “earbud” headphone design varies slightly from one manufacturer to another the same basic characteristics are consistent. A plug is used to connect the headphones to the music player. A wire running from the plug to a point where the two “earbuds” split is referred to as the “y-junction”. From the y-junction a single wire terminates with the earbud itself. One main benefit of this type of headphone versus the conventional over-the-ear headphones is the compact design and ability to store them when not in use. However, when stored, the wires tend to become tangled and crimped, making them difficult to readily access. This invention will address the problem by placing the wire portion of the headphone in a continuous conduit that will make tangling nearly impossible. The conduit will be designed as an aftermarket product that can accommodate nearly all types of earbuds.

### CROSS-REFERENCE TO RELATED APPLICATION

This application is claiming benefit from the previously filed provisional patent application with the Application No. 61/831,084 with a filing date of Jun. 4, 2013

### FIELD OF THE INVENTION

The present invention generally relates to a wire management system for the use with earbud-style headphones.

### BACKGROUND OF THE INVENTION

More and more people are adopting the use of earbud-style headphones in place of the over-the-head style. One particular issue with this style of headphone is that while they take up less space, the wires often become tangled when stored. This leads to problems with wire wear and tear and ultimately functionality. The typical earbud design comprises two individual ear “buds” with single wires that feed into a plug that connects to the audio device. The outer wire sheathing is a rubber material that has a high friction factor. When the wires become tangled, the high friction of the rubber sheathing makes untangling time consuming and difficult. Additionally, the earbud wiring is typically black or white with no ability for customization.

The present invention helps to satisfy all of these problems by creating a durable conduit for which the earbud wires are housed. This conduit not only has a much lower friction factor but, also can be customized with different material colors and optional components. The present invention is intended to be a complimentary product that can be installed over the users existing earbuds.

### SUMMARY OF THE INVENTION

The present invention is a series of hollow fabric tubing's that are joined in a central y-junction. The base fabric of the invention is one that has a significant amount of elasticity to accommodate the various sizes and shapes of earbuds when installed. Each earbud resides within its own tubing to ensure that wire entanglement is minimized. The y-junction has a flap that when closed, conceals the wires from view. The y-junction serves as the passage way whereby the earbud and plug can be feed through their respective tubing's.

Other features and advantages of the present invention will become apparent from the following more detailed description, when taken into conjunction with the accompanying drawings, which illustrate, by way of example, the principles of the invention.

### BRIEF DESCRIPTION OF THE DRAWINGS

FIG. 1 shows an installed view of an exemplary embodiment of the invention;

FIG. 2 shows the close up of the y-junction of the conduit where the wires are fed through of the exemplary embodiment of the invention from FIG. 1.

FIG. 3 shows the close up of the installed earbud within the earbud wire conduit illustrated in FIG. 1.

FIG. 4 shows the close up of the installed earbud plug within the earbud plug wire conduit illustrated in FIG. 1.

FIG. 5 shows the installation of the earbud plug through the y-junction.

FIG. 6 shows the installation of the earbud through the y-junction.

FIG. 7 shows the y-junction in the with the flap in the closed position.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a method of containing the wires of an earbud-design headphone assembly for the purpose of reducing tangling. By placing the earbud wires in a continuously cylindrical conduit the wires are less likely to become tangled during storage.

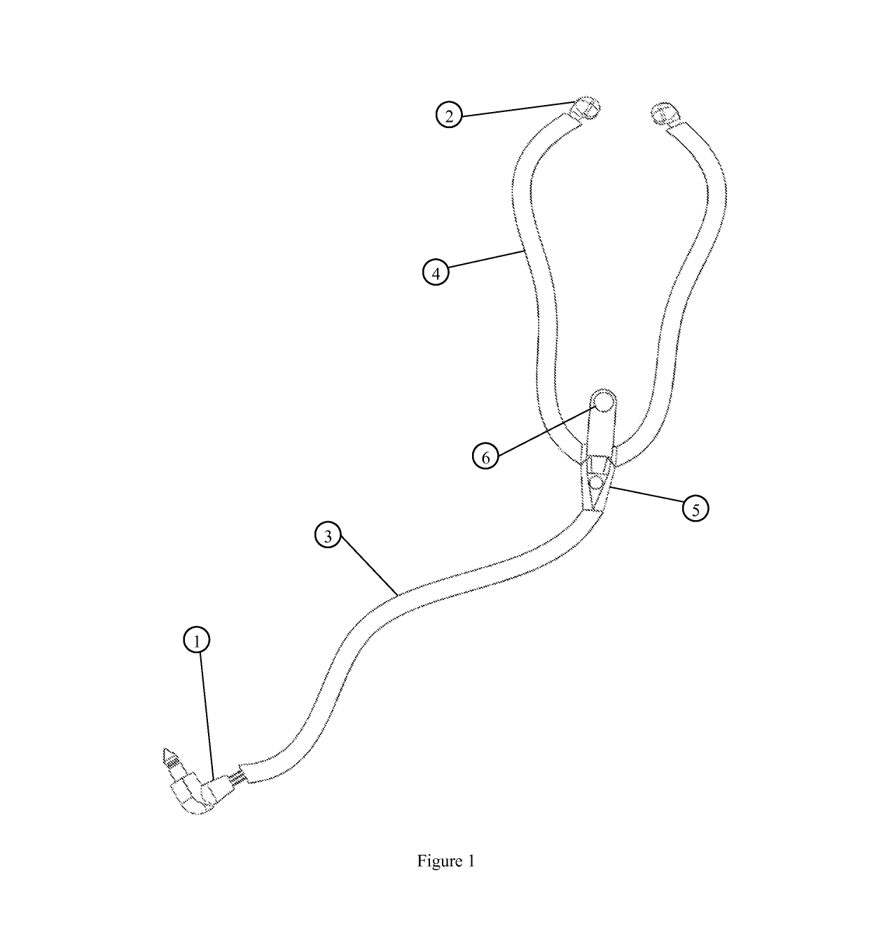

FIG. 1 shows an installed view of an exemplary embodiment of the invention. Two earbud wire conduits (4) are joined to a single plug wire conduit (3) with a y-junction (5). The plug conduit (3) houses the earbud plug wire, which ultimately terminates with the plug (1). The earbud conduits (4) house each individual earbud wires, which ultimately terminate with the earbud (2). The y-junction (5) is attached to the earbud conduits (4) and plug conduit (3) creating a method for feedings the earbuds (2) and plug (1) through the fabric conduits. A closure mechanism (6) on the y-junction and flap provide a means for concealing the wiring once installed.

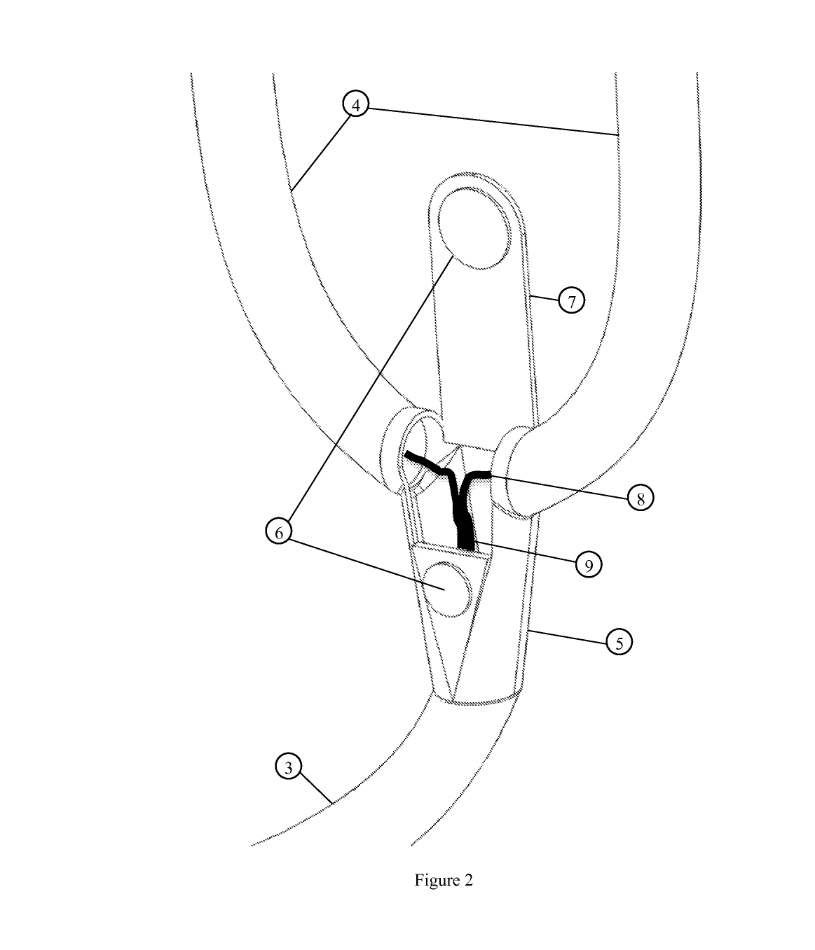

FIG. 2 shows the close up of the y-junction of the conduit of an exemplary embodiment of the invention. The invention may include two earbud wire conduits (4) attached to a central y-junction (5). The earbud wire conduit (4) house each individual earbud wire (8). The invention also has extending from the bottom of the y-junction (5), a plug wire conduit (3). The plug wire conduit (3) houses the plug wiring (9). The y-junction flap (7) has an integral closure mechanism such as a magnet (6) which when joined together with the attractive magnet (6) found on the body of the y-junction (5) conceals the wiring from view.

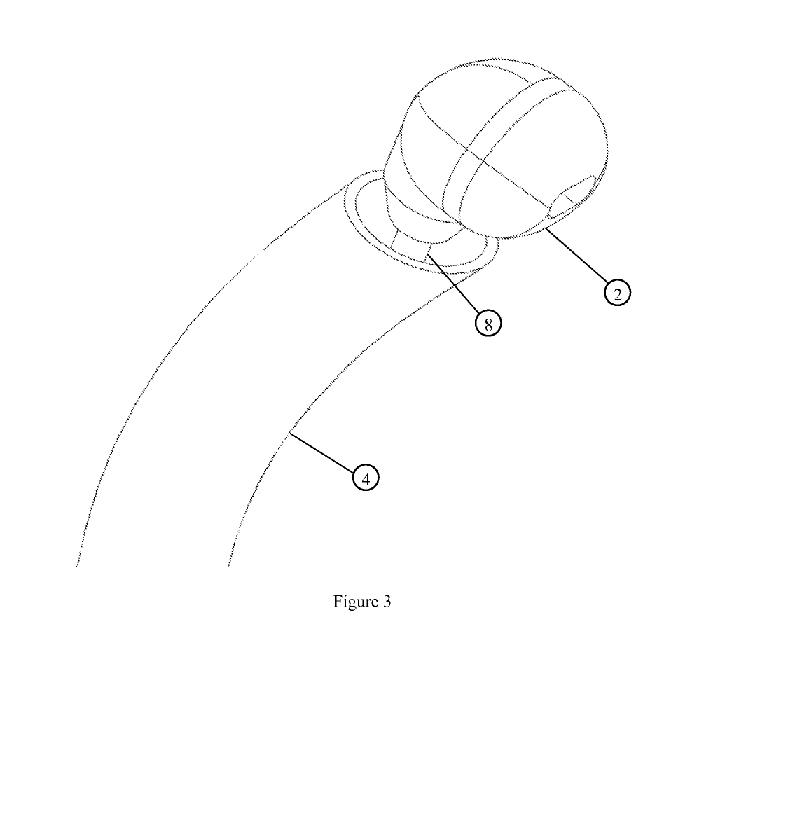

FIG. 3 shows the close up of the installed earbud within the earbud conduit illustrated in FIG. 1. In the installed position, the earbud (2) is shown protruding from the earbud wire conduit (4). The earbud wire conduit (4) is shown around the earbud wiring (8).

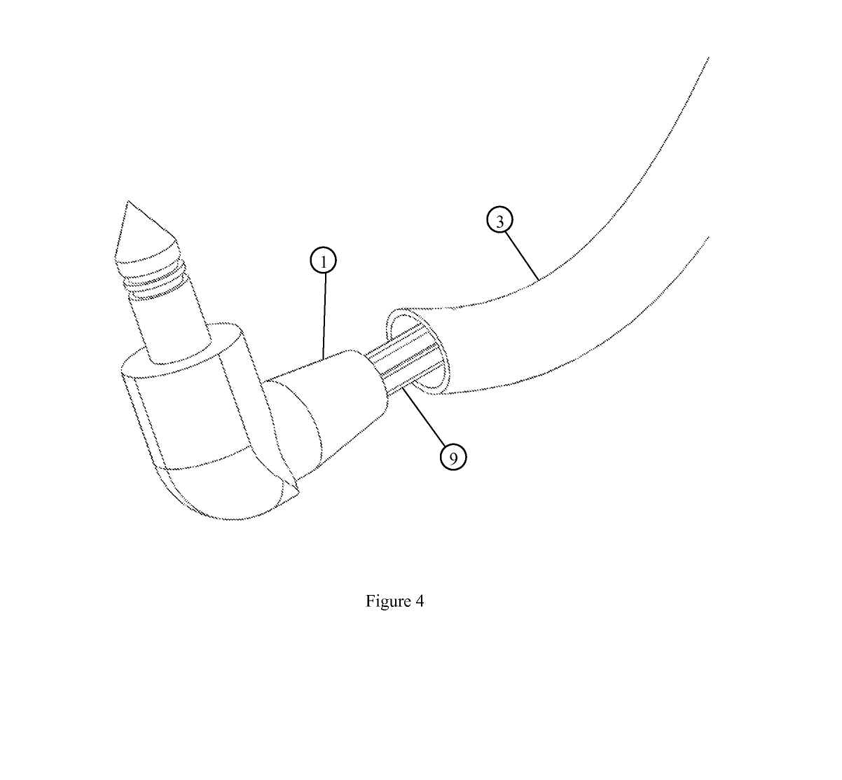

FIG. 4 shows the close up of the installed earbud plug within the earbud plug wire conduit illustrated in FIG. 1. In the installed position, the earbud plug (1) is shown protruding from the earbud plug wire conduit (3). The earbud plug wire conduit (3) is shown around the plug wiring (9).

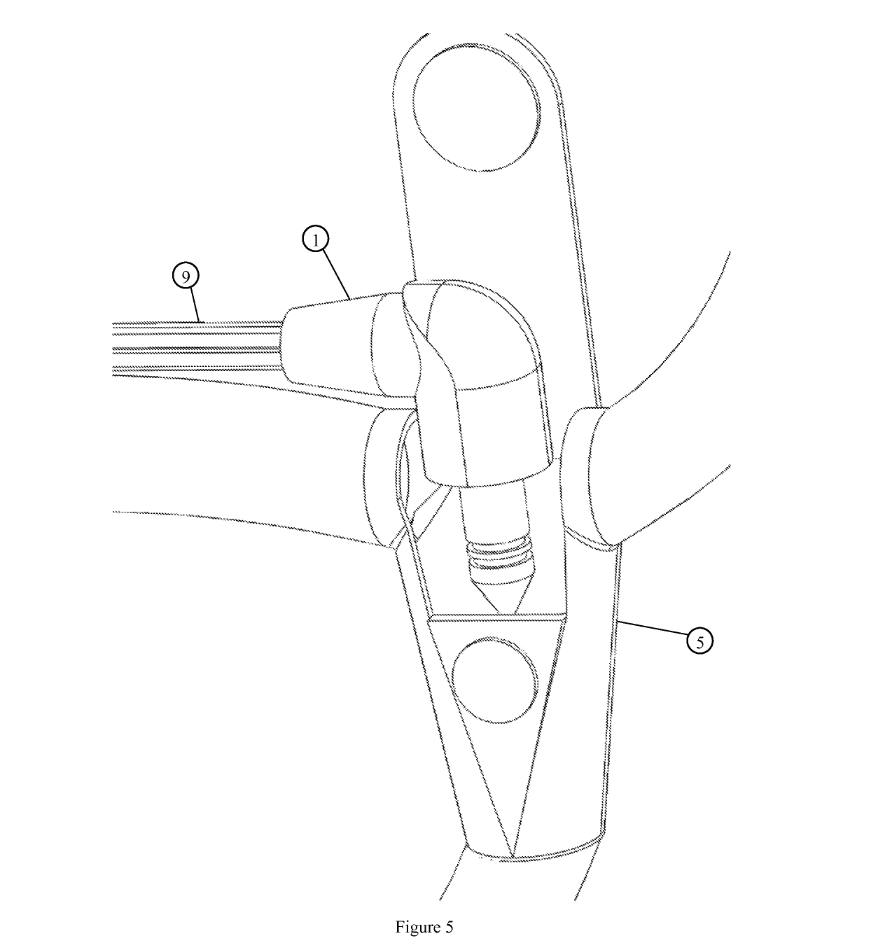

FIG. 5 shows the installation of the earbud plug through the y-junction. The earbud plug (1) is fed through the internal passageway of the y-junction (5) followed by the earbud plug wiring (9).

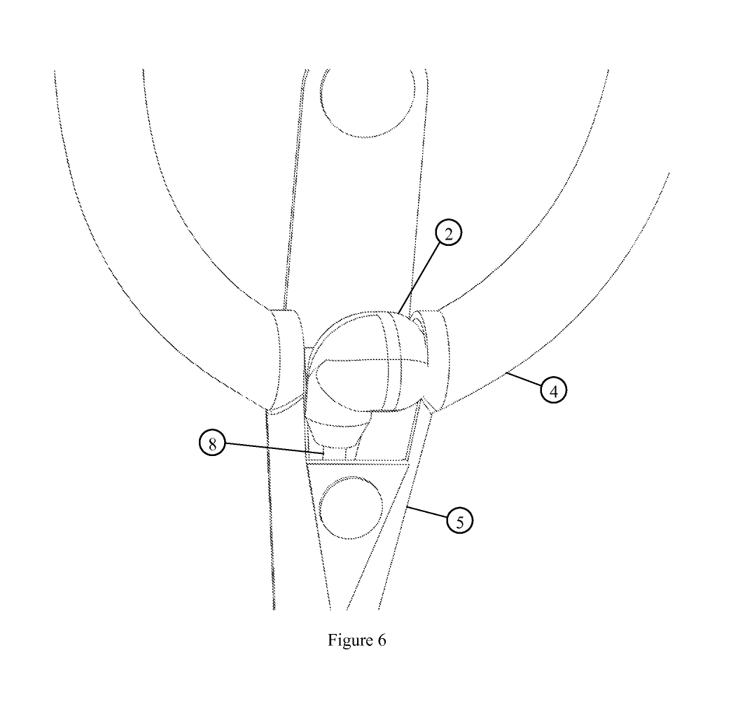

FIG. 6 shows the installation of the earbud through the y-junction. The earbud (2) is fed through the internal passageway of the y-junction (5) connecting to the earbud wire conduit (4).

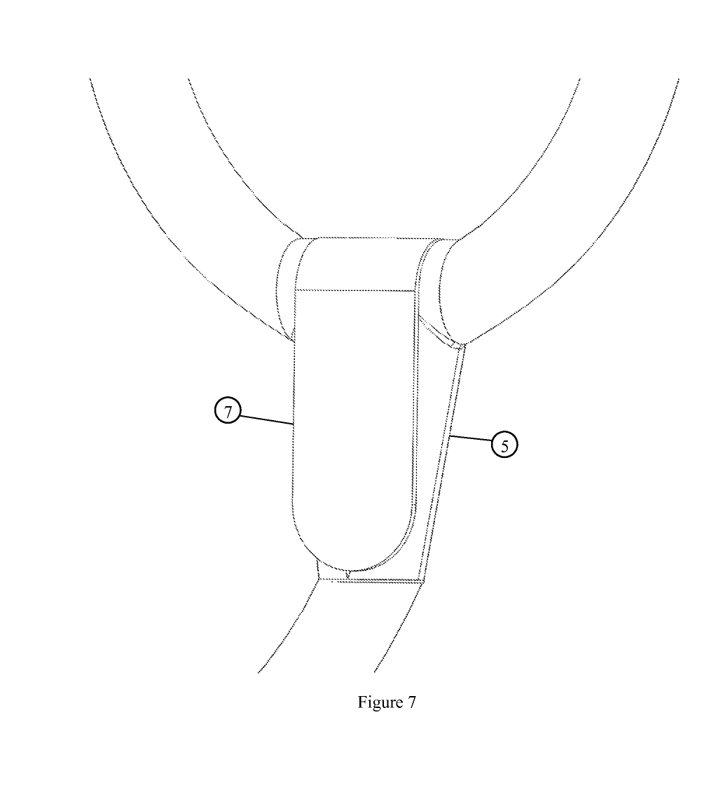

FIG. 7 shows the y-junction in with the flap in the closed position. The y-junction flap (7) is joined to the body of the y-junction (5) to conceal wiring when fully installed.

In an exemplary embodiment, the conduit can be used with all earbud designs and is adaptable in length by way of the tubing material that can stretch and contract to the desired length.

It should be understood, of course, that the foregoing relates to an exemplary embodiments of the invention and that modifications may be made without departing from the spirit and scope of the invention as set forth in the following claim.

1. A tangle-free wire management conduit for earbud headphones comprising:
a hollow, primary tubing to house plug wire; and
a series of secondary hollow tubing's to house the earbud wires; and
a y-junction that joins the two earbud tubings to the primary tubing; and
a Velcro™ flap for concealing wiring.

2. A tangle-free wire management conduit for earbud headphones as described in claim 1 that has the tubing material that can stretch radially to receive the earbud and plug.

3. A tangle-free wire management conduit for earbud headphones as described in claim 1 that utilizes an elastic band at the end of the secondary tubings to retain the earbuds.

4. A tangle-free wire management conduit for earbud headphones as described in claim 1 that receives the plug by feeding through the primary tubing at the y-junction.

5. A tangle-free wire management conduit for earbud headphones as described in claim 1 that receives the earbuds by feeding through the secondary tubings at the y-junction.

6. A tangle-free wire management conduit for earbud headphones comprising:
a hollow, primary tubing to house plug wire; and
a series of secondary hollow tubing's to house the earbud wires; and
a y-junction that joins the two earbud tubings to the primary tubing; and
a fabric flap with magnetic closure for concealing wiring.

7. A tangle-free wire management conduit for earbud headphones as described in claim 6 that has the tubing material that can stretch radially to receive the earbud and plug.

8. A tangle-free wire management conduit for earbud headphones as described in claim 6 that utilizes an elastic band at the end of the secondary tubings to retain the earbuds.

9. A tangle-free wire management conduit for earbud headphones as described in claim 6 that receives the plug by feeding through the primary tubing at the y-junction.

10. A tangle-free wire management conduit for earbud headphones as described in claim 6 that receives the earbuds by feeding through the secondary tubings at the y-junction.

11. A tangle-free wire management conduit for earbud headphones comprising:
a hollow, primary tubing to house plug wire; and
a series of secondary hollow tubing's to house the earbud wires; and
a y-junction that joins the two earbud tubings to the primary tubing; and
a fabric flap with a snap-type closure for concealing wiring.

12. A tangle-free wire management conduit for earbud headphones as described in claim 11 that has the tubing material that can stretch radially to receive the earbud and plug.

13. A tangle-free wire management conduit for earbud headphones as described in claim 11 that utilizes an elastic band at the end of the secondary tubings to retain the earbuds.

14. A tangle-free wire management conduit for earbud headphones as described in claim 11 that receives the plug by feeding through the primary tubing at the y-junction.

15. A tangle-free wire management conduit for earbud headphones as described in claim 11 that receives the earbuds by feeding through the secondary tubings at the y-junction.
